(19) United States
(12) Patent Application Publication
(10) Pub. No.: US 2022/0355974 A1
(43) Pub. Date: Nov. 10, 2022

(54) SYNTHETIC RESIN CONTAINER

(71) Applicant: TOYO SEIKAN CO., LTD., Tokyo (JP)

(72) Inventors: Yoichi TADOKORO, Yokohama-shi (JP); Hiromitsu KIYOTO, Yokohama-shi (JP); Yuuichi MIYAZAKI, Yokohama-shi (JP); Soya YOSHIDA, Yokohama-shi (JP); Atsushi KOMIYA, Yokohama-shi (JP)

(73) Assignee: TOYO SEIKAN CO., LTD., Tokyo (JP)

(21) Appl. No.: 17/872,155

(22) Filed: Jul. 25, 2022

Related U.S. Application Data
(63) Continuation of application No. PCT/JP2021/005134, filed on Feb. 12, 2021.

(30) Foreign Application Priority Data
Mar. 9, 2020 (JP) 2020-039901

(51) Int. Cl. B65D 23/08; B65D 1/02; B32B 1/02; B32B 3/08; B32B 3/30; B32B 7/12

(52) U.S. Cl. CPC B65D 23/085; B65D 1/0215; B65D 1/0246; B65D 1/0284; B32B 1/02; B32B 3/08; B32B 3/30; B32B 7/12; B65D 2501/0027; B32B 2439/70

(57) ABSTRACT

Provided is a synthetic resin container that includes a container main body molded into a predetermined container shape and a covering layer laminated on an outer peripheral surface side of the container main body. A label is mounted on a container body portion. The container main body is provided with a step portion formed by raising or denting a peripheral surface that extends continuously or discontinuously along a predetermined direction and the covering layer is provided with, continuously or discontinuously along the step portion, a linear thin portion that is linearly thinner than a surrounding area. At least part of the label is adhered to a portion of the covering layer adjacent to the linear thin portion.

### CROSS REFERENCE TO RELATED APPLICATIONS

This application is a Rule 53(b) Continuation of International Application No. PCT/JP2021/005134 filed Feb. 12, 2021, which claims priority from Japanese Patent Application No. 2020-039901 filed Mar. 9, 2020, the above-noted applications being incorporated herein by reference in their respective entireties.

### TECHNICAL FIELD

The present disclosure relates to a synthetic resin container having a covering layer laminated on an outer peripheral surface side of a container main body.

### BACKGROUND

Hitherto, synthetic resin containers have been manufactured by forming a preform having a bottomed cylindrical shape and being made of thermoplastic resin such as polyethylene terephthalate, and then molding this preform into a bottle shape by biaxial stretch blow molding or the like. These synthetic resin containers have been used in a wide range of fields as containers for various beverages, various seasonings, and the like.

These synthetic resin containers have become more familiar in recent years, and various proposals have been made accordingly. For example, in Patent Document 1, a composite container has been proposed in which in order to suppress deterioration of contents due to light, a colored plastic member is peelably adhered to an entire area other than a mouth portion of a container main body while having the container main body recyclable in a same known manner.

### SUMMARY

Although it is stated in JP 2016-055523 A that the plastic member can be peeled off from the container main body by cutting the plastic member with a knife or the like, or can be peeled off along a cutting line provided on the plastic member, it is not easy in practice to peel off the plastic member adhered to the entire area of the container main body other than the mouth portion.

The present disclosure has been made in view of the above-described circumstances, and an object of this disclosure is to provide a synthetic resin container that includes a container main body molded into a predetermined container shape and a covering layer laminated on an outer peripheral surface side of the container main body, the synthetic resin container being able to be easily separated into the container main body and the covering layer at the time of disposal.

A synthetic resin container according to the present disclosure includes a container main body molded into a predetermined container shape and a covering layer laminated on an outer peripheral surface side of the container main body, and is configured such that a label is mounted on a container body portion, the container main body is provided with a step portion formed by raising or denting a peripheral surface that extends continuously or discontinuously along a predetermined direction and the covering layer is provided with, continuously or discontinuously along the step portion, a linear thin portion that is linearly thinner than a surrounding area, and at least part of the label is adhered to a portion of the covering layer adjacent to the linear thin portion.

According to the present disclosure, when the label mounted on the container body portion is peeled off from the container, the covering layer on a side of the portion to which the label is adhered in close proximity can be broken along the linear thin portion to form a starting point for tearing the covering layer, thereby making it possible to easily separate the covering layer from the container main body.

### BRIEF DESCRIPTION OF DRAWINGS

FIG. 1 is a front view schematically illustrating a first embodiment of a synthetic resin container according to the present disclosure.

FIG. 2 is a cross-sectional view taken along a line A-A in FIG. 1.

FIG. 3 is an enlarged front view of main parts of the container illustrated in FIG. 1.

FIG. 4 is an explanatory diagram illustrating an example of a process of removing a label in the first embodiment of the synthetic resin container according to the present disclosure.

FIG. 5 is a vertical cross-sectional view illustrating an example of a preform.

FIG. 6 is an explanatory diagram schematically illustrating an example of a blow molding die used in a method for manufacturing the synthetic resin container according to the first embodiment of the present disclosure.

FIG. 7 is an enlarged end view of main parts of the blow molding die for molding the first embodiment of the synthetic resin container according to the present disclosure.

FIG. 8 is an explanatory diagram illustrating how a step portion is shaped by a strip-shaped protruding portion formed on a cavity surface of the blow molding die illustrated in FIG. 7.

FIG. 9 is an explanatory diagram illustrating a process in which the step portion is shaped by the strip-shaped protruding portion formed on the cavity surface of the blow molding die illustrated in FIG. 7.

FIG. 10 is a front view schematically illustrating a second embodiment of a synthetic resin container according to the present disclosure.

FIG. 11 is an enlarged front view of main parts of the container illustrated in FIG. 10.

FIG. 12 is an enlarged front view of main parts illustrating a modified example of a step portion provided in the synthetic resin container according to the present disclosure.

FIG. 13 is a front view schematically illustrating a third embodiment of a synthetic resin container according to the present disclosure.

FIG. 14 is a cross-sectional view taken along a line B-B in FIG. 13.

FIG. 15 is an enlarged end view of main parts of a blow molding die for molding the third embodiment of the synthetic resin container according to the present disclosure.

FIG. 16 is an explanatory diagram illustrating a process in which a band-shaped recessed portion is shaped by a band-shaped protruding portion formed on a cavity surface of the blow molding die illustrated in FIG. 15.

FIG. 17 is an explanatory diagram illustrating a process in which the band-shaped recessed portion is shaped by the band-shaped protruding portion formed on the cavity surface of the blow molding die illustrated in FIG. 15.

FIG. 18 is a front view schematically illustrating a fourth embodiment of a synthetic resin container according to the present disclosure.

FIG. 19 is a cross-sectional view taken along a line C-C in FIG. 18.

FIG. 20 is an enlarged perspective view of main parts of a blow molding die for molding the fourth embodiment of the synthetic resin container according to the present disclosure.

FIG. 21 is an end view taken along a line D-D in FIG. 20.

FIG. 22 is an explanatory diagram illustrating a process in which a depressed portion is shaped by a projecting portion formed on a cavity surface of the blow molding die illustrated in FIG. 21.

FIG. 23 is an explanatory diagram illustrating a process in which the depressed portion is shaped by the projecting portion formed on the cavity surface of the blow molding die illustrated in FIG. 21.

FIG. 24 is an explanatory diagram illustrating a process in which the depressed portion is shaped by the projecting portion formed on the cavity surface of the blow molding die illustrated in FIG. 21.

FIG. 25 is a perspective view schematically illustrating a modification example of a synthetic resin container according to the present disclosure.

### DESCRIPTION OF EMBODIMENTS

Preferred embodiment of the present disclosure will be described below with reference to the accompanying drawings.

### First Embodiment

A first embodiment of the present disclosure will be described.

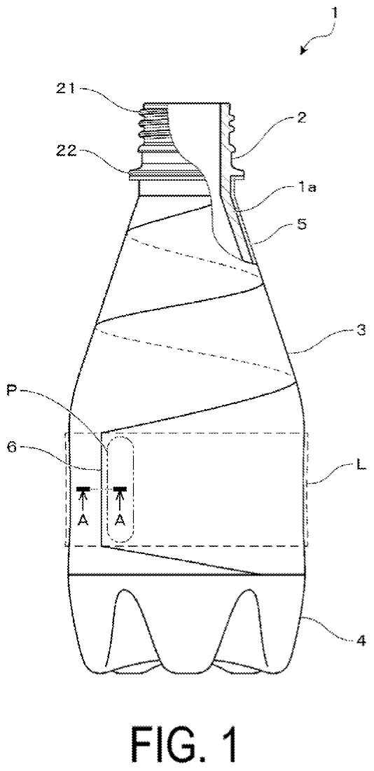

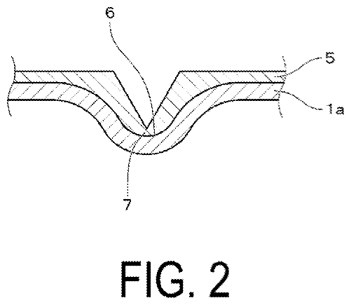

FIG. 1 is a front view schematically illustrating a synthetic resin container 1 according to the present embodiment, and FIG. 2 is an end view taken along a line A-A in FIG. 1.

A container 1 illustrated in these figures includes a container main body 1a molded into a predetermined container shape having a mouth portion 2, a body portion 3, and a bottom portion 4, and a covering layer 5 laminated on an outer peripheral surface side of the container main body 1a. A label L is mounted on the container body portion 3.

In the illustrated example, the container 1 (container main body 1a) is molded into a substantially cylindrical shape, and has a container shape by including the body portion 3 in which a portion on an upper side in a height direction is reduced in diameter toward the mouth portion 2, and the bottom portion 4 is formed into a so-called petaloid shape, but the shape of the container 1 is not limited thereto. Further, in the illustrated example, the label L is indicated by a broken line. The label L cut into a band shape and mounted by wrapping around the entire circumference of the body portion 3 of the container 1 is illustrated, but the shape, mounted area, and mounted position of the label L are not limited thereto.

Here, FIG. 1 illustrates a cross section of a cut out portion from the mouth portion 2 to part of an upper end side of the body portion 3, but thicknesses of the container main body 1a and the covering layer 5 illustrated in the cross section are exaggerated. In other drawings, the thicknesses of the container main body 1a, the covering layer 5, and the like illustrated in the cross section are exaggerated as appropriate.

Further, the height direction refers to a direction orthogonal to a horizontal plane when the container 1 is upright on the horizontal plane with the mouth portion 2 up, and this state (as illustrated in FIG. 1) defines up-down, right-left, and longitudinal-lateral directions of the container 1.

The mouth portion 2 is a cylindrical portion that serves as a spout for the contents. On a side surface of an opening end side of the mouth portion 2, a thread 21 for attaching a lid body (not illustrated) is provided.

In addition, an annular neck ring 22 protruding outward along a circumferential direction is provided on a lower end side of the mouth portion 2.

The covering layer 5 is preferably laminated on the outer peripheral surface side of the container main body 1a such that the covering layer 5 covers an entire surface from a bottom surface of the bottom portion 4 to a peripheral surface of the body portion 3, and a distal end side of the covering layer 5 covers a lower surface of the neck ring 22 provided on the lower end side of the mouth portion 2 and reaches a peripheral end edge of the neck ring 22. Such an aspect is particularly suitable when the covering layer 5 is required to be colored to provide light-shielding properties in order to suppress deterioration of the contents due to light.

In the present embodiment, the body portion 3 of the container main body 1a is provided with a step portion 6 formed by denting a peripheral surface in a substantially U-shaped concave groove shape so as to extend continuously along a predetermined direction.

In the illustrated example, the step portion 6 extends along the height direction within an area on the body portion 3 in which the label is mounted, and is further provided in an area from the upper end side (lower part of the mouth portion 2) to the lower end side (upper part of the bottom portion 4) of the container body portion 3 and includes a portion spirally provided along the peripheral surface of the body portion 3 with an end portion of the step portion 6 extending along the height direction as a base end. Note that in FIG. 1, the step portion 6 on the back face side of the container 1 in the figure is represented by a broken line in order to indicate an aspect in which the step portion 6 is continuously provided along the peripheral surface of the body portion to the upper end side of the body portion 3.

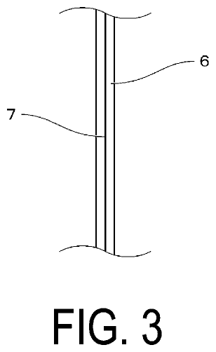

On the other hand, the covering layer 5 laminated on the outer peripheral surface side of the container main body 1a is provided with a linear thin portion 7 that is linearly thinner than a surrounding area along the step portion 6 (see FIGS. 2 and 3).

Note that FIG. 3 is an enlarged front view of main parts of the container 1 according to the present embodiment, and illustrates a state in which the step portion 6 provided in the container body portion 3 extends along the longitudinal direction of the figure.

The label L is mounted on the body portion 3 of the container 1 by adhering one end edge side of the label L in the longitudinal direction to a portion P of the covering layer 5 adjacent to the linear thin portion 7, overlapping another end edge side of the label L in the longitudinal direction on the one end edge side, and adhering both end portions of the label to each other at an overlapping position.

In this way, in a case in which at least part of the label L is adhered to the portion P of the covering layer 5 adjacent to the linear thin portion 7, when the label L is peeled off from the container 1 by picking one end of the label L with fingers in order to separate the label L from the container 1, the portion P of the covering layer 5 adjacent to the linear thin portion 7 to which the label L is adhered is pulled outward from the container in a state of being connected to the label L, allowing the covering layer 5 to be easily broken along the linear thin portion 7 and peeling off the covering layer 5 from the container main body 1a at this point as a starting point.

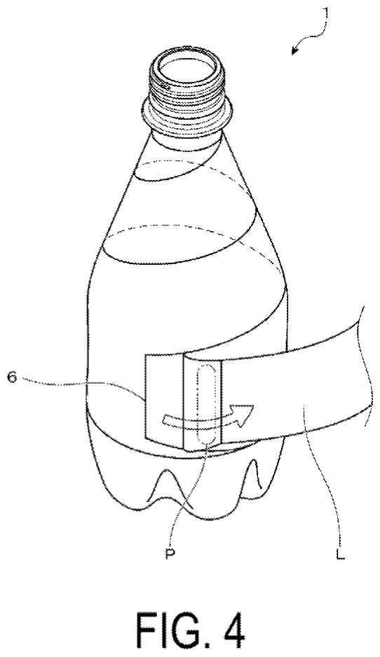

Note that FIG. 4 is an explanatory diagram illustrating an example of a process of removing the label in the synthetic resin container 1 according to the present embodiment.

In addition, according to the present embodiment, the label L and the covering layer 5 can be separated from the container main body 1a and collected as a single piece, without going through the two-step operation of breaking the covering layer 5 by picking and pulling part of the end portion of the covering layer 5 with fingers or the like after peeling off the label L from the outer surface of the covering layer 5, and peeling off the covering layer 5 from the container main body 1a at the broken part as a starting point.

Note that, in order to break the covering layer 5 in this way, it is preferable to provide the step portion 6 such that the linear thin portion 7 extends along the height direction at least within the area in which the label L is mounted as illustrated in the figure. This is because the step portion 6 allows the end side of the label L, which is cut into a band shape, to be adhered as it is along the linear thin portion 7, and the covering layer 5 to be easily broken at the linear thin portion 7 when the label L is peeled off in the peripheral direction of the container.

Further, in the present embodiment, it is sufficient that the linear thin portion 7 be provided in part of the container body portion 3 so as to be a starting point for breaking the covering layer 5 and peeling the covering layer 5 from the container main body 1a. Furthermore, it is preferable that the linear thin portion 7 be provided reaching the upper end side and/or the lower end side of the container body portion 3 with the portion P side to which the label L is adhered in close proximity as the base end and including a portion spirally provided along the peripheral surface of the body portion 3 of the container 1. This is because when the label L is peeled off from the container 1, the covering layer 5 on the side of the portion to which the label L is adhered in close proximity can be broken along the linear thin portion 7, and subsequently the covering layer 5 can be easily torn along the linear thin portion 7 extending toward the upper end side and/or the lower end side of the container body portion 3.

Note that it is sufficient that the label L be adhered to the covering layer 5 with an adhesive or the like having sufficient adhesive strength so that the covering layer 5 can be broken at the linear thin portion 7 without separating the label L and the covering layer 5 when the label L is pulled outward from the container, the adhesion method and the type of adhesive for adhering the label L and the covering layer 5 not being limited thereto.

Such a synthetic resin container 1 can be produced by blow molding a preform 10 with a blow molding die 100 having a predetermined internal shape, which includes a preform main body 10a, which has a bottomed cylindrical shape with one end open, in which a mouth portion 20 is formed on one end side of a cylindrical body portion 30 and a hemispherical bottom portion 40 is formed on another end side, and a covering material layer 50 laminated on an outer peripheral surface side of the preform main body 10a, to form a container main body 1a and a covering layer 5, then adhering the label L cut into a predetermined shape to a portion of the covering layer 5 adjacent to the linear thin portion 7 and mounting the label L on the container body portion 3.

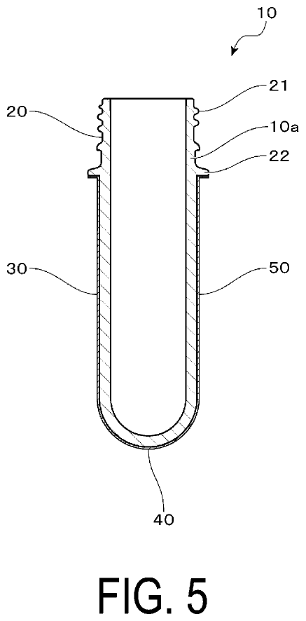

FIG. 5 illustrates an example of the preform 10. In order to manufacture the container 1 with the laminated covering layer 5 in the aspect described above, it is sufficient to use the preform 10 in which the covering material layer 50 is laminated on the outer peripheral surface side of the preform main body 10a such that the covering material layer 50 covers the entire surface from the bottom portion 40 to just below the mouth portion 20, and a distal end side of the covering material layer 50 covers a lower surface of the neck ring 22 provided on a lower end side of the mouth portion 20 and reaches a peripheral end edge of the neck ring 22.

Here, in the present embodiment, in a state illustrated in FIG. 5 with the mouth portion 20 facing up, up, down, left, right, vertical and horizontal directions of the preform 10 are defined as in the container 1.

The preform 10 is softened by heating to a state ready for blow molding, then set in a blow molding die and stretched axially (longitudinally) by a stretching rod as necessary from just below the neck ring 22 to the bottom portion 40, while being stretched axially and circumferentially (laterally) by high-pressure fluid blowing. A cavity shape of the blow molding die is then transferred to the stretched portion, molding the container 1 with a predetermined container shape. At this time, the container main body 1a is molded by the stretched preform main body 10a, and the covering material layer 50 laminated on the preform main body 10a is molded together with the preform main body 10a to form the covering layer 5 laminated on the container main body 1a.

When the preform 10 is blow molded in this way, the mouth portion 20 of the preform 10, including the neck ring 22, is not stretched by the blow molding and simply becomes the mouth portion 2 of the container 1. Thus, by using the preform 10 illustrated in FIG. 5, the distal end side of the covering material layer 50 covering the lower surface of the neck ring 22 also simply becomes the distal end side of the covering layer 5 of the container 1, and thus the container 1 with the laminated covering layer 5 in the aspect described above can be manufactured.

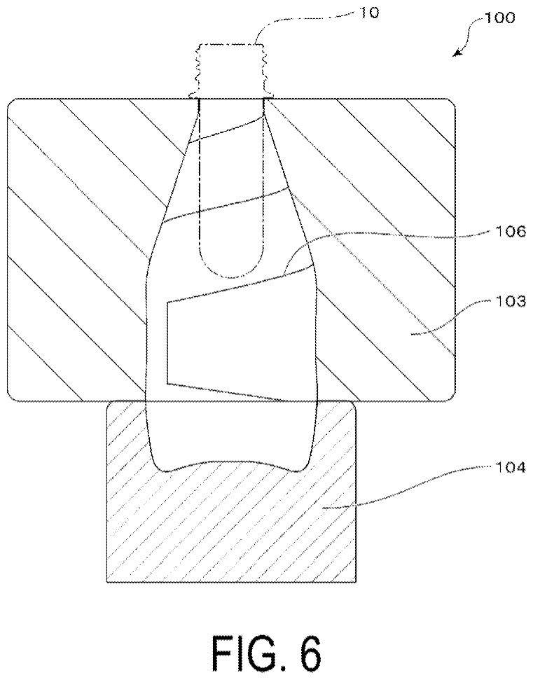

FIG. 6 is an explanatory diagram schematically illustrating the blow molding die 100 for manufacturing the first embodiment of the synthetic resin container according to the present disclosure.

The blow molding die 100 is for molding the preform 10 into a predetermined container shape by biaxial stretch blow molding. When the blow molding die 100 is closed, a cavity corresponding to the container shape of the container 1 is formed in the molding die, the body portion 3 is shaped by a body die 103, and the bottom portion 4 is shaped by a base die 104. The body die 103 can be a pair of split molding dies that can be opened and closed.

Note that, in FIG. 6, the preform 10 set in the blow molding die 100 is illustrated by an alternate long and short dash line.

In the present embodiment, on a cavity surface of the body die 103, a strip-shaped protruding portion 106 shaping the step portion 6 formed denting in a substantially U-shaped concave groove shape in the container main body 1a of the container 1 protrudes from the peripheral surface in a tapered shape toward a tip and extends continuously along a predetermined direction.

By providing the strip-shaped protruding portion 106 protruding in a tapered shape toward the tip, a height difference is formed from an inner peripheral surface of the cavity to the tip of the strip-shaped protruding portion 106, providing a step on the inner peripheral surface of the cavity. Accordingly, at a top of such a strip-shaped protruding portion 106, an edge portion 107 formed by the tip of the strip-shaped protruding portion 106 and two side surfaces that rise from the inner peripheral surface of the cavity toward the tip of the strip-shaped protruding portion 106 is provided.

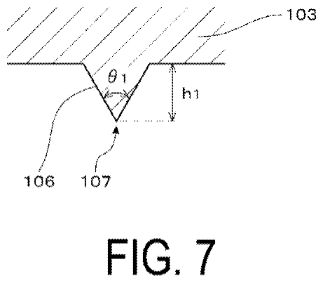

Note that FIG. 7 is an enlarged end view of main parts schematically illustrating a lateral end face in the vicinity of the strip-shaped protruding portion 106 of the body die 103 used in the present embodiment.

In order to manufacture the container 1 using such a blow molding die 100, first, as described above, the preform 10 is readied for the blow molding by heating, and then set in the blow molding die 100. At that time, the preform main body 10a is softened to have stretchability by heating the preform main body 10a to a temperature equal to or lower than the melting point and higher than the glass transition point of a resin material forming the preform main body 10a. On the other hand, the covering material layer 50 is heated to a temperature near the melting point of the resin material forming the covering material layer 50 (e.g., [melting point−30]° C. to [melting point+30]° C.) so that the covering material layer 50 is kept in a molten state or a semi-molten state with high fluidity.

In order to heat both the preform main body 10a and the covering material layer 50 as described above when heating the preform 10, for example, the preform 10 is heated from the outside using an infrared heater or the like, and the preform 10 is also heated from the inside by, for example, inserting a rod-shaped high-frequency induction heating element generating heat by high-frequency induction heating into the preform 10 to adjust the heating temperature from the inside and outside as appropriate.

When the blow molding of the preform 10 is started in the blow molding die 100, the stretched portion comes into contact with the cavity surface, and the step portion 6 is shaped in the preform main body 10a (the body portion 3 of the container main body 1a) by the strip-shaped protruding portion 106.

At this time, the step portion 6, which is formed in the preform main body 10a, is not shaped as the shape of the strip-shaped protruding portion 106 that protrudes from the inner peripheral surface of the cavity in a tapered shape toward the tip. The preform main body 10a is stretched so as to be curved with the covering material layer 50 interposed between the strip-shaped protruding portion 106 and the preform body 10a, with respect to the tapered shape of the strip-shaped protruding portion 106. In this way, the step portion 6 formed by denting the peripheral surface in a gentle U shape, that is, formed denting in a substantially U shape, is shaped.

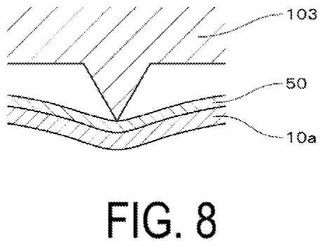

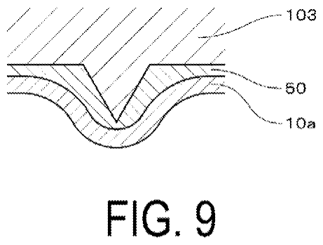

In contrast, the covering material layer 50 is in a molten state or semi-molten state with high fluidity. Thus, as the preform main body 10a is stretched, when the covering material layer 50 is pressed against the edge portion 107 formed at the top of the strip-shaped protruding portion 106, a portion of the covering material layer 50 that is pressed against the edge portion 107 is pushed away and flows to fill spaces between the portions of the preform main body 10a that are stretched curved and the inner peripheral surfaces of the cavity. In this way, the covering material layer 50 is shaped so as to have substantially the shape of the strip-shaped protruding portion 106, and is molded so as to be linearly thinned along the edge portion 107 of the strip-shaped protruding portion 106 (see FIGS. 8 and 9).

As a result, in the container 1 after blow molding, the linear thin portion 7 is formed in the covering layer 5 along a groove bottom of the step portion 6 so as to be linearly thinner than the surrounding area (see FIG. 2).

When the linear thin portion 7 is formed in the covering layer 5 in this way, the narrower and clearer the linear thin portion 7 is formed, the easier it is to tear the covering layer 5 along the linear thin portion 7. It is preferable to appropriately design the shape, dimensions, and the like of the strip-shaped protruding portion 106 from this perspective.

For example, a height difference h₁ between the tip of the strip-shaped protruding portion 106 and the inner peripheral surface of the cavity, an angle θ₁ of the edge portion 107 formed at the top of the strip-shaped protruding portion 106, that is, an apex angle θ₁ of the strip-shaped protruding portion 106, and the like are appropriately designed from the above perspective.

Note that as long as the linear thin portion 7 can be formed in the covering layer 5 as described above, the edge portion 107 may be rounded.

In the present embodiment, as a resin material forming the container main body 1a (preform main body 10a), ethylene terephthalate thermoplastic polyester (glass transition point: 50° C. to 90° C., melting point: 200° C. to 275° C.) such as polyethylene terephthalate can be preferably used.

As a resin material forming the covering layer 5 (covering material layer 50), it is preferable to use a thermoplastic resin that is incompatible with the resin material forming the container main body 1a from the perspective of enabling easy separation between the container main body 1a and the covering layer 5.

For example, when ethylene terephthalate thermoplastic polyester is used as the resin material forming the container main body 1a, a polyolefin resin such as polypropylene (melting point: 160° C. to 170° C.) or polyethylene (melting point: 80° C. to 140° C.) can be used as the resin material forming the covering layer 5. The polyolefin resin is commonly preferable because of having a lower melting point than the ethylene terephthalate thermoplastic polyesters, making it easier to adjust the heating temperature when heating the preform 10 to bring the covering material layer 50 into a molten state or a semi-molten state while softening the preform main body 10a to be stretchable during blow molding, but is not limited thereto.

For example, when gas barrier properties are required for the container 1, a thermoplastic resin having gas barrier properties such as ethylene-vinyl alcohol copolymer or polymethaxylylene adipamide (MXD6) can be used as the resin material forming the covering layer 5.

Further, when light-shielding properties are required for the container 1, a pigment, a colorant, or the like can be added to the resin material forming the covering layer 5 to color the container 1 in a desired hue. In order to enhance the decorative effect, a plurality of pigments and colorants can also be mixed and added to form a marble pattern. Various additives can be added to the resin material forming the covering layer 5 as necessary, without being limited by the recyclability required for the container main body 1a.

It is sufficient that at least part of the label L be adhered to the outer surface of the covering layer 5 in the container 1 molded in this manner, at a portion adjacent to the linear thin portion 7, with an adhesive or the like, and that the label L be mounted by a method suitable to the form of the label L, the mounting method not being limited thereto.

### Second Embodiment

Next, a second embodiment of the present disclosure will be described.

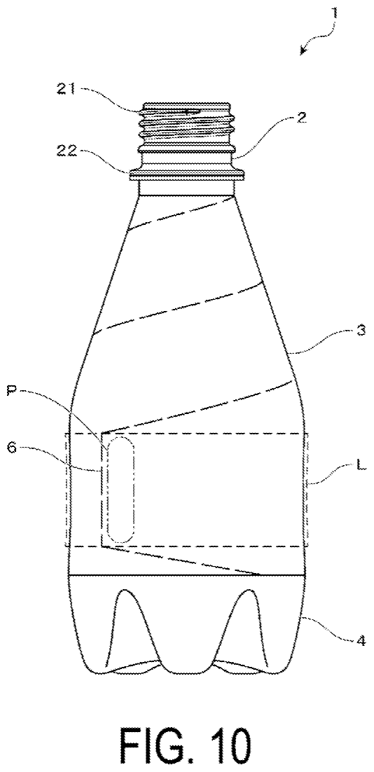

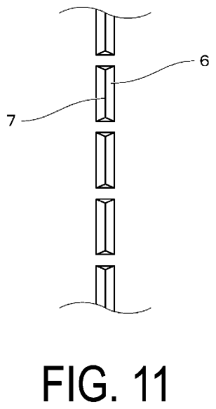

FIG. 10 is a front view schematically illustrating the synthetic resin container 1 according to the present embodiment, and FIG. 11 is an enlarged front view of main parts of the container 1 according to the present embodiment and illustrates a state in which the step portion 6 provided in the container body portion 3 extends along the longitudinal direction of the figure, as in FIG. 3.

In the first embodiment described above, the container 1 is constituted of the container main body 1a provided such that the step portion 6 formed by denting the peripheral surface of the container main body 1a in the substantially U-shaped concave groove shape extends continuously along the predetermined direction, and the covering layer 5 provided with the linear thin portion 7 extending continuously along the groove bottom of the step portion 6 in the predetermined direction.

In contrast, in the present embodiment, the container 1 is constituted of the container main body 1a provided such that the step portion 6 formed by denting the peripheral surface of the container main body 1a in the substantially U-shaped concave groove shape extends discontinuously along the predetermined direction, and the covering layer 5 provided with the linear thin portion 7 extending discontinuously along the groove bottom of the step portion 6 in the predetermined direction.

As in the first embodiment, the label L cut into a band shape is mounted by adhering one end edge side of the label L in the longitudinal direction to the portion P of the covering layer 5 adjacent to the linear thin portion 7 and wrapping the label L around the entire circumference of the body portion 3 of the container 1.

The step portion 6 extends discontinuously along the height direction within an area on the body portion 3 in which the label is mounted, and further extends discontinuously in an area from the upper end side (lower part of the mouth portion 2) to the lower end side (upper part of the bottom portion 4) of the container body portion 3 and includes a portion spirally provided along the peripheral surface of the body portion 3 with an end portion of the step portion 6 along the height direction as a base end.

According to the container 1 of the present embodiment, when the label L is peeled off from the container 1 by picking one end of the label L with fingers, the portion P of the covering layer 5 adjacent to the linear thin portion 7 to which the label L is adhered is pulled outward from the container in a state of being connected to the label, allowing the covering layer 5 to be easily broken along the discontinuously formed perforated linear thin portion 7. Pulling the label L continuously so as to be peeled off from the container 1, the covering layer 5 can be easily peeled off from the container main body 1a by tearing the covering layer 5 along the discontinuously formed perforated linear thin portion 7 in a state of being connected to the side of the portion to which the label L is adhered in close proximity.

In the present embodiment, in production of the container 1 by blow molding the preform 10 as described above, the blow molding die 100 processed in the same manner as in the first embodiment is used to produce the container 1 in the same manner as in the first embodiment, except that the strip-shaped protruding portion 106, which shapes the step portion 6 in the container main body 1a of the container 1, is provided on the cavity surface of the body die 103 so as to protrude from the peripheral surface of the body die 103 in a tapered shape toward the tip and extend discontinuously along a predetermined direction.

In forming the linear thin portion 7 in the covering layer 5, the strip-shaped protruding portion 106 discontinuously extending along the predetermined direction can be formed in a perforated shape perforated at appropriately adjusted distances such that the strength of the covering layer 5 in the vicinity of the linear thin portion 7 can be stabilized, so long as the ease of breaking the covering layer 5 is not hindered.

In addition, by providing another step portion 61 formed by denting the peripheral surface in a substantially U-shaped concave groove shape and having a different groove width and a groove depth between the step portions 6 provided extending discontinuously along the predetermined direction, two types of step portions (6, 61) having different groove widths and groove depths may be provided alternately so as to be continuously extended in the predetermined direction.

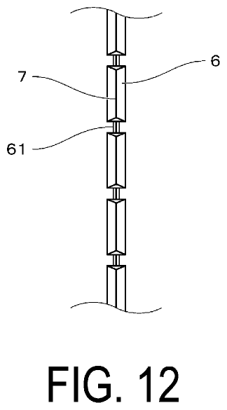

FIG. 12 is an enlarged front view of main parts illustrating a modified example of such a step portion 6, and as in FIG. 3, illustrates a state in which the step portion 6 provided in the container body portion 3 extends along the longitudinal direction of the figure.

Such a container 1 can be formed by using the blow molding die 100 in which the height to the tip of the strip-shaped protruding portion 106 and the width of the strip-shaped protruding portion 106 are appropriately designed to have a desired shape for the strip-shaped protruding portion 106 provided on the inner peripheral surface of the cavity of the body die 103. Depending on the shape of the strip-shaped protruding portion 106 provided on the body die 103, it is also possible to alternately form the linear thin portions 7 having different thicknesses in the covering layer 5.

Although the present embodiment differs from the first embodiment in the above-described respects, the other configurations are similar to those of the first embodiment, and thus redundant descriptions will be omitted.

### Third Embodiment

Next, a third embodiment of the present disclosure will be described.

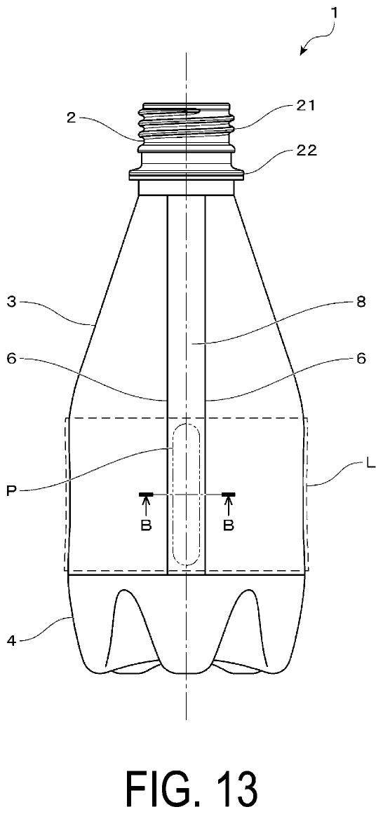

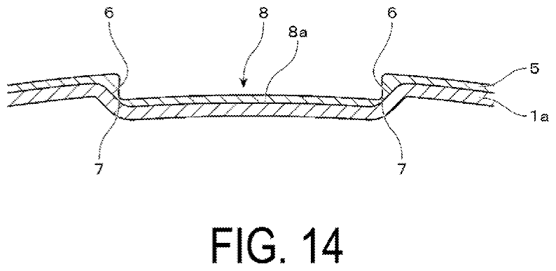

FIG. 13 is a front view schematically illustrating the synthetic resin container 1 according to the present embodiment, and FIG. 14 is an end view taken along a line B-B in FIG. 13.

In the first embodiment described above, the container 1 is constituted of the container main body 1a provided with the step portion 6 formed by denting the peripheral surface of the container main body 1a in the substantially U shape and the covering layer 5 provided with the linear thin portion 7 along the step portion 6, in which the linear thin portion 7 is provided in the covering layer 5 in the area in which the label L is mounted along the height direction, and also includes the portion spirally provided along the peripheral surface of the container body portion 3 with the side of the portion to which the label L is adhered in close proximity as the base end.

In contrast, in the present embodiment, the container 1 is constituted of the container main body 1a provided with a band-shaped recessed portion 8 in which the peripheral surface of the container main body 1a is recessed toward the inside of the container with a predetermined width and extending along a predetermined direction, and formed with the step portions 6 rising from a bottom surface 8a of the band-shaped recessed portion 8 and connected to the peripheral surface of the body portion 3 at both end edges in the width direction of the band-shaped recessed portion 8, and the covering layer 5 provided with the linear thin portions 7 along the step portions 6 extending in the predetermined direction.

The label L cut into a band shape is mounted by adhering one end edge side of the label L in the longitudinal direction to the portion P of the covering layer 5 adjacent to the linear thin portions 7 and wrapping the label L around the entire circumference of the body portion 3 of the container 1.

In the illustrated example, the band-shaped recessed portion 8 is provided so as to extend from the upper end side to the lower end side of the body portion 3 along the height direction, and the linear thin portions 7 are configured to include portions extending toward the upper end side and the lower end side of the body portion 3, with the side of the portion to which the label L is adhered in close proximity as a base end.

According to the container 1 of the present embodiment, when the label L is peeled off from the container 1 by picking one end of the label L with fingers, the portion P of the covering layer 5 adjacent to the linear thin portions 7 to which the label L is adhered is pulled outward from the container in a state of being connected to the label, allowing the covering layer 5 to be easily broken along the linear thin portions 7. Pulling the label L continuously so as to be peeled off from the container 1, the covering layer 5 can be easily peeled off from the container main body 1a by tearing the covering layer 5 along the continuously provided linear thin portions 7 from the side of the portion to which the label L is adhered in close proximity.

As illustrated in the figure, when the label L is adhered to a portion corresponding to the bottom surface 8a of the band-shaped recessed portion 8, that is, between the two rows of linear thin portions 7 provided at a predetermined distance, by pulling the label L outward from the container, the covering layer 5 is separated in a band shape along the two rows of linear thin portions 7. This allows the covering layer 5 remaining on the container main body 1a to be easily peeled off from the location in which the covering layer 5 is separated in a band shape and the container main body 1a is exposed, but the position in which the label L is adhered is not limited to such an aspect. It is sufficient that the label L be adhered to a portion adjacent to the linear thin portions 7 so that the covering layer 5 can be torn along at least one row of linear thin portion 7.

In the present embodiment, in production of the container 1 by blow molding the preform 10 as described above, the blow molding die 100 is used in which a band-shaped protruding portion 108 for shaping the band-shaped recessed portion 8 in the container main body 1a of the container 1 is provided on the cavity surface of the body die 103.

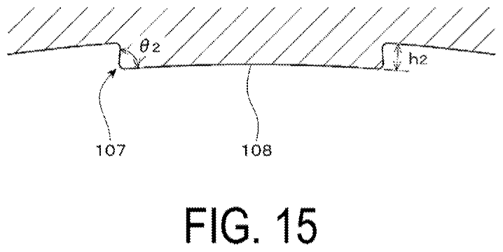

The band-shaped protruding portion 108 protrudes with a predetermined width and both end edges thereof in the width direction are provided at steep angles so that the edge portions 107 that shape the step portions 6 are formed along both end edges of the band-shaped protruding portion 108 (see FIG. 15). In the illustrated example, such a band-shaped protruding portion 108 extends from the upper end side to the lower end side of the body die 103.

Note that FIG. 15 is an enlarged end view of main parts schematically illustrating a lateral end face in the vicinity of the band-shaped protruding portion 108 of the body die 103 used in the present embodiment.

The container 1 can be produced in the similar manner as in the first embodiment except for using such a body die 103.

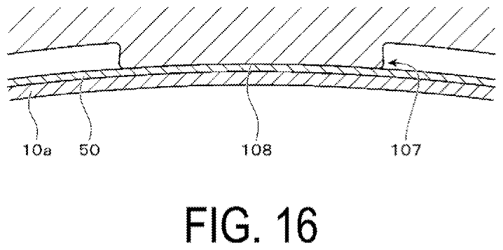

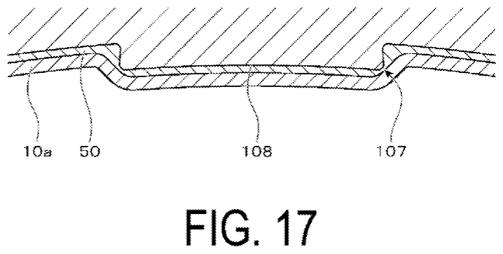

Here, the step portion that is shaped in the preform main body 10a in blow molding is not shaped as the shape of the strip-shaped protruding portion 106, as described above. Similarly, the band-shaped recessed portion 8 that is shaped in the preform main body 10a is not shaped as the shape of the band-shaped protruding portion 108 provided at steep angles so as to form the edge portions 107 at both end edges. As illustrated in FIGS. 16 and 17, the preform main body 10a is stretched such that both end sides of a portion in contact with the upper surface of the band-shaped protruding portion 108 with the covering material layer 50 interposed therebetween are curved against steps on both end edge sides of the band-shaped protruding portion 108. The band-shaped recessed portion 8 is thus shaped so that the step portions 6 rising from the bottom surface 8a of the band-shaped recessed portion 8 and connected to the peripheral surface of the body portion 3 are formed at both end edges of the band-shaped recessed portion 8 (see FIG. 14).

In contrast, as described above, the covering material layer 50 is in a molten state or semi-molten state with high fluidity. Thus, as the preform main body 10a is stretched so as to be curved against the steps on both end edge sides of the band-shaped protruding portion 108, when the covering material layer 50 is pressed against the edge portions 107 formed along both end edges of the band-shaped protruding portion 108, portions of the covering material layer 50 that are pressed against the edge portions 107 flow, as pushed away, to fill spaces between the portions of the preform main body 10a that are stretched so as to be curved, and the steps on both end edge sides of the band-shaped protruding portion 108. In this way, the covering material layer 50 is shaped so as to have substantially the shape of the band-shaped protruding portion 108, and is molded so as to be linearly thinned along the edge portions 107 of the band-shaped protruding portion 108.

As a result, in the container 1 after blow molding, the linear thin portions 7 are formed in the covering layer 5 along the step portions 6 formed at both end edges of the band-shaped recessed portion 8, which are linearly thinner than a surrounding area (see FIG. 14).

When the linear thin portions 7 are formed in the covering layer 5 in this way, the narrower and clearer the linear thin portions 7 are formed, the easier it is to tear the covering layer 5 along the linear thin portions 7. It is preferable to appropriately design the shape, dimensions, and the like of the band-shaped protruding portion 108 from this perspective.

For example, a step h₂ of the band-shaped protruding portion 108, that is, a height difference h₂ between the upper surface of the band-shaped protruding portion 108 and the adjacent cavity surface in the illustrated example, and an angle θ₂ of the edge portions 107 formed along both end edges of the band-shaped protruding portion 108, that is, an angle θ₂ formed between the upper surface of the band-shaped protruding portion 108 and a side surface of the band-shaped protruding portion 108 that forms the edge portion 107 together with this upper surface, are appropriately designed from the above perspective.

Note that as long as the linear thin portions 7 can be formed in the covering layer 5 as described above, the edge portions 107 formed along the both end edges of the band-shaped protruding portion 108 may be rounded.

Although the present embodiment differs from the first embodiment in the above-described respects, the other configurations are similar to those of the first embodiment, and thus redundant descriptions will be omitted.

### Fourth Embodiment

Next, a fourth embodiment of the present disclosure will be described.

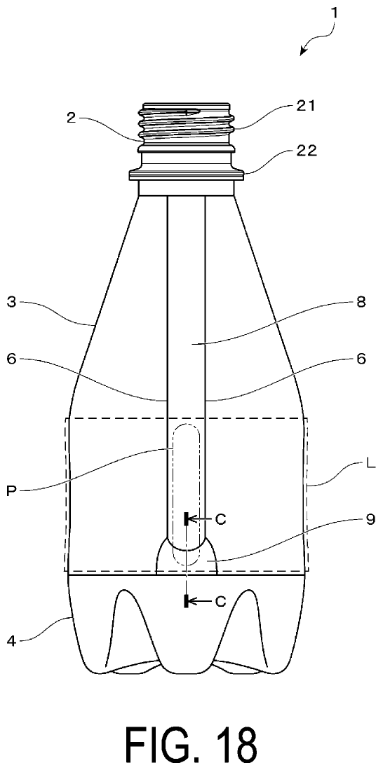

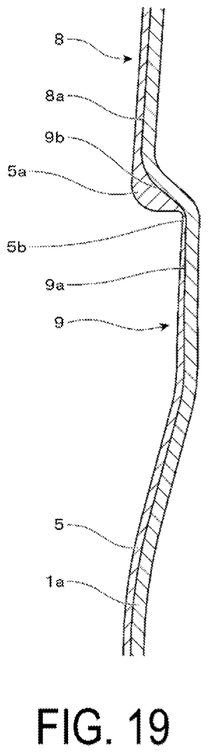

FIG. 18 is a front view schematically illustrating a fourth embodiment of the synthetic resin container 1 according to the present embodiment. FIG. 19 is a cross sectional view taken along a line C-C in FIG. 18.

The present embodiment differs from the previous embodiments in that a depressed portion 9, which is lower than a surrounding area, is provided in connection with the step portions 6 within the area in which the label is mounted on the container main body 1a.

In the illustrated example, similar to the third embodiment, the container 1 is constituted of the container main body 1a provided with the band-shaped recessed portion 8 in which the peripheral surface of the container main body 1a is recessed toward the inside of the container with a predetermined width and extending along a predetermined direction, and formed with the step portions 6 rising from the bottom surface 8a of the band-shaped recessed portion 8 and connecting to the peripheral surface of the body portion 3 at both end edges in the width direction of the band-shaped recessed portion 8, and the covering layer 5 provided with the linear thin portions 7 along the step portions 6 extending in a predetermined direction.

Further, in the present embodiment, the depressed portion 9 is provided on the lower end side of the band-shaped recessed portion 8 provided in the container main body 1a. The depressed portion 9 is provided such that a bottom surface 9a is recessed toward the inside of the container more than the peripheral surface of the adjacent body portion 3 and the bottom surface 8a of the band-shaped recessed portion 8, and is bordered by an edge portion 9b that rises from the bottom surface 9a of the depressed portion 9 and is connected to both the adjacent peripheral surface of the body portion 3 and the bottom surface 8a of the band-shaped recessed portion 8 (see FIG. 19).

The covering layer 5 laminated on the outer peripheral surface side of the container main body 1a includes a thick portion 5a in which a thickness of the covering layer 5 changes and becomes thicker than the surrounding area at a portion located on the edge portion 9b that rises from the bottom surface 9a of the depressed portion 9 and is connected to the bottom surface 8a of the band-shaped recessed portion 8. In addition, a thin portion 5b in which the thickness of the covering layer 5 changes and becomes thinner than the surrounding area is formed in a portion connected to the thick portion 5a and located on the bottom surface 9a side of the depressed portion 9 (see FIG. 19).

Further, the thin portion 5b formed in the depressed portion 9 provided in connection with the step portions 6 is formed in connection with the linear thin portions 7 provided along the step portions 6.

In this way, the covering layer 5 can be broken more easily not only by providing the linear thin portions 7 in the covering layer 5, but also by providing the thin portion 5b formed in the depressed portion 9 in connection with the linear thin portions 7.

In the illustrated example, the label L cut into a band shape is mounted by bringing one end edge side of the label L in the longitudinal direction adjacent to the linear thin portions 7 of the covering layer 5 and adhering the one end edge side of the label L to the covering layer 5 at the portion P in an area close to or partially overlapping the depressed portion 9, and wrapping the label L around the entire circumference of the body portion 3 of the container 1.

According to the container 1 of the present embodiment, when the label L is peeled off from the container 1 by picking one end of the label L with fingers, the portion P of the covering layer 5 adjacent to the linear thin portions 7 to which the label L is adhered is pulled outward from the container in a state of being connected to the label, allowing the covering layer 5 to be easily broken along the thin portion 5b formed on the bottom surface 9a side of the depressed portion 9 and the linear thin portions 7, and the thick portion 5a side formed on the edge portion 9b of the depressed portion 9 to separate from the thin portion 5b side. Pulling the label L continuously so as to be peeled off from the container 1, the covering layer can be easily peeled off from the container main body 1a by tearing the covering layer 5 along the continuously provided linear thin portions 7 from the side of the portion to which the label L is adhered in close proximity.

In the present embodiment, in production of the container 1 by blow molding the preform 10 as described above, the blow molding die 100 is used in which the band-shaped protruding portion 108 for shaping the band-shaped recessed portion 8 and a projecting portion 109 for shaping the depressed portion 9 in the container main body 1a of the container 1 are provided on the cavity surface of the body die 103.

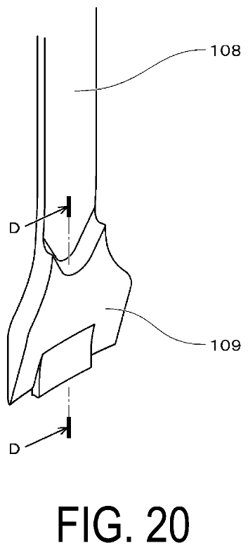

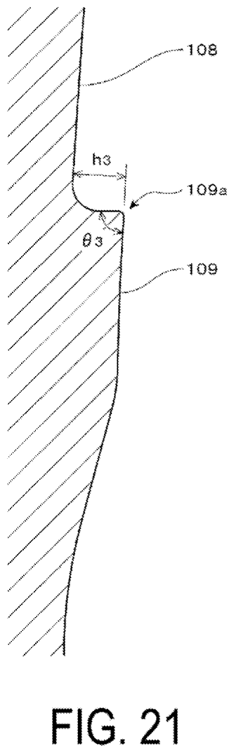

The band-shaped protruding portion 108 protrudes with a predetermined width, is provided at steep angles so that the edge portions 107 are formed along both end edges in the width direction, and extends from the upper end side to the lower end side of the body die 103. On the lower end side of the body die 103, the projecting portion 109, which shapes the depressed portion 9 in the container main body 1a of the container 1, is provided in connection with one end side of the band-shaped protruding portion 108. The projecting portion 109 projects higher than the surrounding area, that is, projects higher than the adjacent cavity surface and the upper surface of the band-shaped protruding portion 108, and is provided at a steep angle so that an edge portion 109a is formed on a peripheral edge (see FIGS. 20 and 21).

Note that FIG. 20 is an enlarged perspective view illustrating main parts including part of the band-shaped protruding portion 108 and the projecting portion 109 on the cavity surface of the body die 103 of the blow molding die 100 for molding the fourth embodiment of the synthetic resin container according to the present disclosure, and FIG. 21 is an end view taken along a line D-D in FIG. 20.

The container 1 can be produced in the similar manner as in the first embodiment except for using such a body die.

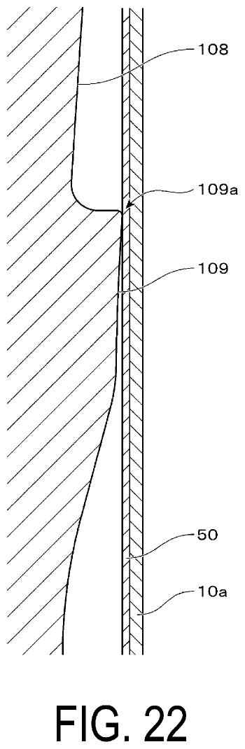

Here, the band-shaped recessed portion 8 that is shaped in the preform main body 10a in blow molding is not shaped as the shape of the band-shaped protruding portion 108, as described above. Similarly, the depressed portion 9 that is shaped in the preform main body 10a is not shaped as the shape of the projecting portion 109 provided at a steep angle so as to form the edge portion 109a at a peripheral edge. As illustrated in FIGS. 22 to 24, when the stretched preform main body 10a comes into contact with the upper surface of the projecting portion 109 with the covering material layer 50 interposed therebetween, a portion on the peripheral edge side in which the edge portion 109a is formed is stretched so as to be curved against a step on the peripheral edge side. This causes the depressed portion 9 to be shaped so as to be bordered by the edge portion 9b that rises from the bottom surface 9a and is connected to both the adjacent peripheral surface of the body portion 3 and the bottom surface 8a of the band-shaped recessed portion 8 (see FIG. 19).

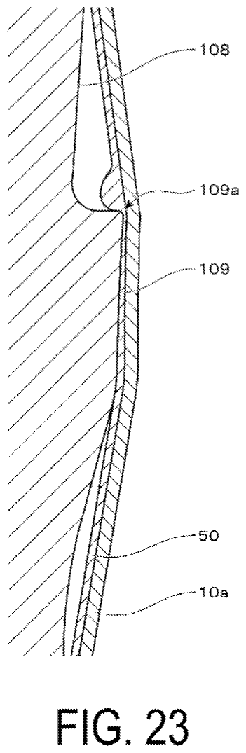

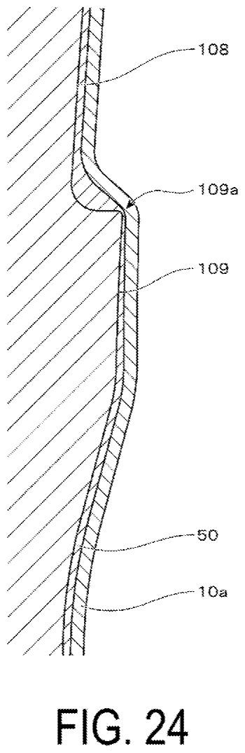

At that time, when there is a step having a certain height or more on the peripheral edge side in which the edge portion 109a of the projecting portion 109 is formed, as the preform main body 10a is stretched so as to be curved against this step, the covering material layer 50 sandwiched between the preform main body 10a and the upper surface of the projecting portion 109 is pressed, and flows so as to expand from the upper surface of the projecting portion 109 into the peripheral edge side (see FIG. 23). In this way, on the peripheral edge side in which the edge portion 109a of the projecting portion 109 is formed, the covering material layer 50 is molded thicker so that a resin pool is formed in a space between the step and the preform main body 10a, whereas the covering material layer 50 sandwiched between the preform main body 10a and the upper surface of the projecting portion 109 is molded thinner (see FIG. 24).

As a result, in the container 1 after blow molding, in the covering layer 5, the thick portion 5a in which the thickness of the covering layer 5 changes and becomes thicker than the surrounding area is formed at a portion located on the edge portion 9b of the depressed portion 9 that rises from the bottom surface 9a of the depressed portion 9, and the thin portion 5b in which the thickness of the covering layer 5 changes and becomes thinner than the surrounding area is formed at a portion in connection with this thick portion 5a and located on the bottom surface 9a side of the depressed portion 9 (see FIG. 19).

When the thick portion 5a and the thin portion 5b are formed in connection with each other in the covering layer 5 in this way, it is preferable to appropriately design the shape, dimensions, and the like of the projecting portion 109 from the perspective of more favorably breaking the thin portion 5b and separating the thick portion 5a from the thin portion 5b side, as described above.

For example, a step h₃ on the peripheral edge side in which the edge portion 109a of the projecting portion 109 is formed, that is, a height difference h₃ between the upper surface of the projecting portion 109 and the upper surface of the band-shaped protruding portion 108 in the illustrated example, and an angle θ₃ of the edge portion 109a formed on the peripheral edge of the projecting portion 109, that is, an angle θ₃ formed between the upper surface of the projecting portion 109 and a side surface of the projecting portion 109 forming the edge portion 109a together with this upper surface, are appropriately designed from the above perspective.

Note that, as long as the thick portion 5a and the thin portion 5b can be formed in connection with each other in the covering layer 5 as described above, the edge portion 109a formed on the peripheral edge of the projecting portion 109 may be rounded as illustrated in FIG. 21.

In addition, in the present embodiment, the projecting portion 109, on the side in connection with the band-shaped protruding portion 108, is provided such that the side surface forming the edge portion 109a together with the upper surface of the projecting portion 109 is concavely curved toward both end edges of the band-shaped protruding portion 108.

Providing the projecting portion 109 in such a shape is preferable because the covering material layer 50 is pressed between the preform main body 10a and the upper surface of the projecting portion 109, and expands from the upper surface of the projecting portion 109 to the peripheral edge side so as to gather on the center side of the side surface, whereby the thick portion 5a formed in the covering layer 5 can be made thicker and more easily separated from the thin portion 5b side.

Although the present embodiment differs from the first embodiment in the above-described respects, the other configurations are similar to those of the first embodiment, and thus redundant descriptions will be omitted.

Although the present disclosure has been described above with reference to the preferred embodiments, the present disclosure is not limited only to the embodiments described above, and various modifications can be made within the scope of the present disclosure.

For example, the label L is not limited to that illustrated in the present embodiments as long as at least part of the label L is adhered to a portion which is the outer surface of the covering layer 5 and is adjacent to the linear thin portion 7, and one end of the label L can be peeled off from the container 1 with fingers.

Not only a roll label that is mounted by wrapping around the body portion 3 of the container 1, but also a tack label that is cut into a predetermined shape and mounted by covering only a portion of the container 1 or a pop sticker (also referred to as an attention sticker) that is cut into a predetermined shape and mounted by adhering only part of the pop sticker to the container 1 and leaving the rest of the pop sticker floating from the outer surface of the container 1 may be applied.

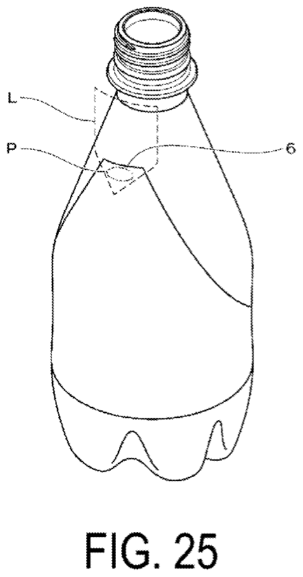

FIG. 25 is a perspective view schematically illustrating a modification example of the synthetic resin container according to the present disclosure. As illustrated in FIG. 25, also when the pop sticker is uses as the label L, as long as part of the label L is adhered to a portion adjacent to the step portion 6 of the container main body 1a, that is, a portion adjacent to the linear thin portion 7 provided in the covering layer 5, when the label L is peeled off from the container 1 by picking one end of the label L with fingers, the portion P of the covering layer 5 adjacent to the linear thin portion 7 to which the label L is adhered is pulled outward from the container in a state of being connected to the label L, allowing the covering layer 5 to be easily broken along the linear thin portion 7. Pulling the label L continuously so as to be peeled off from the container 1, the covering layer 5 can be easily peeled off from the container main body 1a by tearing the covering layer 5 along the continuously provided linear thin portion 7 connected to the side of the portion in which the label L is adhered in close proximity.

In addition, in the embodiments described above, the step portion 6 of the container main body 1a is provided such that the linear thin portion 7 extends from the upper end side to the lower end side of the body portion 3 with the side of the portion P to which the label L is adhered in close proximity as a base end, and after breaking the covering layer 5 on the side of the portion to which the label L is adhered in close proximity, subsequently, the covering layer 5 is torn along the linear thin portion 7 that extends toward the upper end side and the lower end side of the container body portion 3. However, the linear thin portion 7 other than the portion to which the label L is adhered in close proximity may be omitted. In this case, after breaking the covering layer 5, the covering layer 5 may be held directly by hand and further torn so that the covering layer 5 can be peeled off from the container 1, or intermittent break portions such as perforations along a predetermined direction may be formed in the covering layer 5 using a CO₂ laser or the like, as necessary, to assist in tearing the cover layer 5.

Further, the step portion 6 may be modified as appropriate, as long as the step portion 6 is configured to provide the linear thin portion 7. For example, the step portion 6 according to the first embodiment may be provided in two rows, as in the third embodiment, as the step portions 6 formed at both end edges of the band-shaped recessed portion 8, rising from the bottom surface 8a of the band-shaped recessed portion 8, and connected to the peripheral surface of the body portion 3. The two rows of step portions 6 thus formed may extend along the height direction within the area in which the label L is mounted, or the two rows of step portions 6 may be provided spirally along the peripheral surface of the container body portion 3. Alternatively, the peripheral surface of the container main body 1a may be formed such that the step portion 6 formed so as to be raised from one peripheral surface and connected to another peripheral surface is provided in a single row along a predetermined direction.

Further, the shape of the projecting portion 109 that shapes the depressed portion 9 in the container main body 1a of the container 1 is not limited to the example illustrated in the embodiment described above. As long as the edge portion 109a of the projecting portion is provided in a steep angle shape so that the thick portion 5a and the thin portion 5b, which allow the covering layer 5 to be easily broken, are formed, the shape of the projecting portion 109 can be changed as appropriate according to the shape of the container 1 and the form of the step portion.

In short, as long as the synthetic resin container according to the present disclosure includes a container main body molded into a predetermined container shape and a covering layer laminated on an outer peripheral surface side of the container main body, and is configured such that the label is mounted on a container body portion, the container main body is provided with a step portion formed by raising or denting a peripheral surface that extends continuously or discontinuously along a predetermined direction, and the covering layer is provided with, continuously or discontinuously along the step portion, a linear thin portion that is linearly thinner than a surrounding area, and at least part of the label is adhered to a portion of the covering layer adjacent to the linear thin portion, the present disclosure can be modified without any limitation except the configuration necessary to implement the spirit and scope of the disclosure.

While preferred embodiments of the disclosure have been described above, it is to be understood that variations and modifications will be apparent to those skilled in the art without departing from the scope and spirit of the disclosure. The scope of the disclosure, therefore, is to be determined solely by the following claims.

What is claimed is:

1. A synthetic resin container, comprising:
a container main body molded into a predetermined container shape; and
a covering layer laminated on an outer peripheral surface side of the container main body, wherein
a label is mounted on a container body portion,
the container main body is provided with a step portion formed by raising or denting a peripheral surface that extends continuously or discontinuously along a predetermined direction and
the covering layer is provided with, continuously or discontinuously along the step portion, a linear thin portion that is linearly thinner than a surrounding area, and
at least part of the label is adhered to a portion of the covering layer adjacent to the linear thin portion.

2. The synthetic resin container according to claim 1, wherein
the label cut into a band shape is mounted by wrapping the label on the container body portion, and
one end edge side of the label in a longitudinal direction is adhered to the portion of the covering layer adjacent to the linear thin portion.

3. The synthetic resin container according to claim 1, wherein the linear thin portion extends along a height direction at least within an area in which the label is mounted.

4. The synthetic resin container according to claim 1, wherein the linear thin portion includes a portion spirally provided along a peripheral surface of the container body portion with a side of the portion to which the label is adhered in close proximity as a base end.

5. The synthetic resin container according to claim 1, wherein
the step portion is formed by denting the peripheral surface of the container main body in a concave groove shape, and
the covering layer is provided with the linear thin portion along a groove bottom of the step portion formed denting in the concave groove shape.

6. The synthetic resin container according to claim 1, wherein
the container main body is provided with a depressed portion that is lower than a surrounding area and is connected to the step portion within an area in which the label is mounted, and
the covering layer includes a thick portion in which a thickness of the covering layer changes and becomes thicker than the surrounding area at a portion located on an edge portion of the depressed portion that rises from a bottom surface of the depressed portion, and a thin portion in which the thickness of the covering layer changes and becomes thinner than the surrounding area at a portion in connection with the thick portion and located on a bottom side of the depressed portion.
